(19) United States
(12) Patent Application Publication
(10) Pub. No.: US 2022/0109145 A1
(43) Pub. Date: Apr. 7, 2022

(54) NOVEL VANADIUM OXIDE CATHODE MATERIAL

(71) Applicant: The Trustees of Indiana University, Bloomington, IN (US)

(72) Inventor: Jian Xie, Carmel, IN (US)

(21) Appl. No.: 17/477,706

(22) Filed: Sep. 17, 2021

Related U.S. Application Data
(63) Continuation of application No. 14/319,671, filed on Jun. 30, 2014, now abandoned.

(51) Int. Cl. H01M 4/36; H01M 4/62; H01M 4/04; H01M 4/1391; H01M 4/131

(52) U.S. Cl. CPC H01M 4/366; H01M 4/625; H01M 4/131; H01M 4/0419; H01M 4/1391; H01M 4/0471

(57) ABSTRACT

An electrode material for an electrochemical cell comprising a plurality of stacked vanadium pentoxide ribbons defining a substrate, a plurality of graphene oxide sheets infiltrating the substrate to define an electrode material, and a plurality of water molecules present between adjacent vanadium oxide ribbons. Each respective graphene oxide sheet is positioned between two adjacent vanadium pentoxide ribbons. The electrode material is about 2 weight percent graphene oxide. Water molecules are present in a ratio of at least about 0.3 water molecules per V₂O₅.

### CROSS-RELATED APPLICATIONS

The present application is a continuation application of U.S. application Ser. No. 14/319,671, filed Jun. 30, 2014, the entire disclosure of which is being expressly incorporated herein by reference.

### TECHNICAL FIELD

The present novel technology relates generally to electrochemistry and, more particularly, to graphene-vanadium oxide aerogel composites as electrodes for lithium ion batteries.

### BACKGROUND

Since the introduction of lithium ion batteries twenty-five years ago, the demand for increasingly higher specific capacity and specific energy batteries has steadily increased with the advance of portable electronics, electric vehicles (EVs), hybrid electric vehicles (HEVs) and the like. Likewise, the need for alternative fuel sources has grown over the last decades, due to such factors as the rise of oil prices, the increase in global population, and the pollution generated by internal combustion vehicles. As world population continues to grow, so will the number of vehicles and along with that the demand to for more efficient vehicles that require fewer natural resources and generate less pollution.

Advancement in battery technology has made the dream of replacing internal combustion engines with electric motors a reality, reducing the consumption of liquid hydrocarbon fuels. Implementation of battery powered electric motor vehicles still faces stiff opposition as they carry a higher cost, still have limited range, and suffer weight parity issues when compared to traditional internal combustion vehicles. Further, the batteries of choice, Li-ion batteries, suffer from short cycle lives and exhibit significant degradation over time, making battery powered vehicles less attractive.

In most lithium ion batteries, the cathodes are typical metal oxides, serving as the intercalation compounds for Li⁺ ion insertion during the discharge. Many different metal oxides have been explored as the cathode materials. Among those commonly used cathode materials (such as LiCoO₂ (274 mAh/g) and LiFePO₄ (170 mAh/g)), vanadium pentoxide (V₂O₅) has the theoretical capacity of 443 mAh/g (with three lithium ion insertion) and possible specific energy 1218 mWh/g (assuming nominal 2.75 V discharge voltage). In addition to its specific capacity, vanadium has the advantage of being quite abundant in nature, making its availability high and cost low. The combination of high specific capacity/energy and high abundance makes V₂O₅ a very attractive candidate for LIB applications, and extensive effort has been devoted to develop V₂O₅ as a high performance cathode material for lithium ion batteries. However, due to its low electrical conduction, slow lithium diffusion and irreversible phase transitions upon deep discharge, poor rate capability and limited long-term cycleability issues presented by V₂O₅ cathode material, the practical applications of V₂O₅ as a cathode choice have been limited.

Electrical reactivity of vanadium oxides varies with synthesis conditions and phases. For crystalline V₂O₅, the irreversible phase transformation from γ phase (orthorhombic) to the tetragonal ω phase occurs when more than 2 Li⁺ were intercalated into V₂O₅, limited the specific capacity to 300 mAh/g and results in the poor deep discharge capacity due to the decreased Li+diffusion coefficient. Thus, there is a need for an electrode material for lithium ion batteries that takes advantage of the benefits of V₂O₅ without being hampered by its inherent drawbacks. The present novel technology addresses this need.

### BRIEF DESCRIPTION OF DRAWINGS

FIGS. 1A graphically illustrates charge/discharge curves of pure V₂O₅ and V₂O₅/2% graphene cells at 0.05 C.

FIG. 1B graphically illustrates charge/discharge curves of pure V₂O₅ and V₂O₅/2% graphene cells at 0.05 C and 1.0 C.

FIG. 2 graphically illustrates rate performance of pure V₂O₅ and V₂O₅/2% graphene cells based on C-rate.

FIG. 3 graphically illustrates cycle life of pure V₂O₅, V₂O₅ with 2% and 10% graphene cells at 1 C rate.

FIG. 4 graphically illustrates specific Capacity of V₂O₅ with different graphene content loading at 0.01 C rate.

FIG. 5 graphically illustrates electrochemical impedance spectroscopy of pure V₂O₅ and V₂O₅/2% graphene cells.

FIG. 6A-D graphically illustrate cryo-TEM imaging of the solution of pure decavanadic acid (HVO₃) during nucleation (0 min), vanadium oxide ribbons growth (1 h), continuous growth of ribbons (1 h30 min.), and fully growth of the vanadium oxide ribbons (2 weeks).

FIG. 7A-D graphically illustrate cryo-TEM imaging of the solution of bare decavanadic acid during nucleation (30 min), vanadium oxide ribbons growth (2 h), continuous growth of V₂O₅ ribbons (4 h), and fully growth of the vanadium oxide ribbons (3 weeks).

FIG. 8 graphically illustrates transmission electron microscopy of as-synthesized Graphene /V₂O₅ after calcination.

FIG. 9A is a 2D contour plot of vanadium K-edge XANES of Li/V₂O₅ pouch cell during the first four discharge/charge process.

FIG. 9B graphically illustrates V K-edge XANES as a function of state of discharge for a V₂O₅/Graphene nanocomposite lithiated during the first cycle of discharge.

FIG. 10A graphically illustrates HRXRD characterization of V₂O₅/Graphene a) XRD patterns of the V₂O₅ xerogel during heat-treatment process between room temperature and 600° C., showing that the bipyramid structure will collapse at around 300° C.

FIG. 10B shows XRD patterns of V₂O₅ with aerogel during heat-treatment process between room temperature and 600° C., showing that the bipyramid structure will persist until 450° C.

FIG. 11 graphically compares thermogravimetric analysis (TGA) curves between bare V₂O₅ xerogel and V2O5/graphene composite material.

FIG. 12 is a perspective view of the interaction of vanadium oxide and graphene oxide sheets, with water pillars between adjacent vanadium oxide sheets.

### DETAILED DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

Electrical reactivity of vanadium oxides varies with synthesis conditions and phases. For crystalline V₂O₅, the irreversible phase transformation from y phase (orthorhombic) to the tetragonal ω phase occurs when more than 2 Li⁺ were intercalated into V₂O₅, limited the specific capacity to 300 mAh/g and results in the poor deep discharge capacity due to the decreased Li⁺ diffusion coefficient. However, compared to crystalline (orthorhombic) V₂O₅, amorphous V₂O₅ gels offer considerable advantages by virtue of their morphology. The vanadium oxide gels, V₂O₅.nH₂O owns a ribbon-like structure with high surface area, which can be considered to a more versatile host for Li⁺ ions intercalation and exhibit improved capacity of lithium (i.e. moles of Li per mole of V₂O₅) when they were tested as the cathode materials. The basic units of V₂O₅ xerogel are the sheets comprised of two vanadium oxide layers.

When the distance of the adjacent layers of V₂O₅ increases, the insertion capacity will increase instead. So hydrated vanadium pentoxide gels, V₂O₅·nH₂O (the distance between the adjacent layers is 11.52 Å), possesses the Li interacalation capacity about 1.4 times larger than that of orthorhombic V₂O₅ (the distance between the adjacent layers is 4.56 Å). However, even for the amorphous V₂O₅ gels, the same challenges, low electrical conduction (both intraparticle (within a V₂O₅ particle) and interparticle (between V₂O₅ particles) conduction), slow lithium diffusion and the structure stability/reversibility, still remain. Effort have been taken to improve the conductivity, coating V₂O₅ xerogels with conductive materials, using single wall carbon nanotube to form nano-composites, doping metals and organic ploymers. However, these measures can only improve the V₂O₅ xerogels to a certain degree and neither of them could significantly improve the structure stability and reversibility. Hence, a comprehensive approach, which can simultaneously deal with all of three issues, is needed.

Graphene is a single atomic layer of sp²-bonded carbon atoms arranged in a honeycomb crystal structure and can be viewed as an individual atomic plane of the graphite structure. In graphene, each carbon atom uses 3 of its 4 valance band (2s, 2p) electrons (which occupy the sp² orbits) to form covalent bonds with the neighboring carbon atoms in the same plane. Each carbon atom in the graphene contributes its fourth lone electron (occupying the p₂ orbit) to form a delocalized electron system, a long-range it-conjugation system shared by all carbon atoms in the graphene plane. Such a long-range it-conjugation in graphene yields extraordinary electrical, mechanical, and thermal properties. Graphene can be prepared using the chemical reduction of graphene oxide (GO), which is a layered stack of oxidized graphene sheets with different functional groups. Thus GO can be easily dispersed in the form of single sheet in water at low concentrations.

In one embodiment of the present novel technology, single-atomic-layer-thick graphene oxide sheets are inserted between V₂O₅ nanoribbions or substrates to construct a V₂O₅/graphene nanocomposite, typically via a sol-gel process or the like. The nanocomposite exhibits improved intraparticle electronic conduction because of good conductivity of graphene, and the lithium ion diffusion is improved because of the diffusion length is shortened. Furthermore, the formed smaller V₂O₅ grain size in the nanocomposite reduces the stress within particles, leading to better structure stability and cycle life. As detailed below, the present novel technology relates a simple and unique method to synthesize V₂O₅/graphene nanocomposites via sol-gel process giving rise to a novel class of V₂O₅/graphene nanocomposites which exhibit excellent electrochemical performance as cathode materials for Li ion batteries. Characterization of such materials as conducted using synchrotron XRD and XANES as well as the cryo-TEM for the materials structure and the formation mechanism.

The vanadium pentoxide xerogels were prepared by a simple modified ion-exchange method. A 0.1 M solution of sodium metavanadate (NaVO₃, >99.5%) was eluted through a column loaded with a proton-exchange resin (50-100 mesh). The obtained yellow solution of decavanadic acid (HVO₃) was aged in a glass container for two weeks in order to obtain a mature homogeneous vanadium oxide hydrogel. Dried xerogel was obtained by freeze-drying the hydrogel under vacuum.

Graphene oxide (GO) was prepared using a modified Hummer's method. An additional graphite oxidation procedure was carried out first. Two (2) g graphite flakes was mixed with 10 mL of concentrated H₂SO₄, 2 g of (NH₄)₂S₂O₈, and 2 g of P₂O₅. The obtained mixture was heated at 80° C. for 4 h under constant stirring. Then the mixture was filtered and washed thoroughly with DI water. After dried in an oven at 80° C. overnight, this pre-oxidized graphite was then subjected to oxidation using the Hummer's method. Two (2) g of pre-oxidized graphite, 1 g of sodium nitrate and 46 ml of sulfuric acid were mixed and stirred for 15 min in an iced bath. Then, 6 g of potassium permanganate was slowly added to the obtained suspension solution for another 15 min. After that, 92 ml DI water was slowly added to the suspension, while the temperature kept constant at about 98° C. for 15 min. After the suspension has been diluted by 280 mL DI water, 10 ml of 30% H₂O₂ was added to reduce the unreacted permanganate. Finally, the resulted suspension was centrifuged several times in order to remove the unreacted acids and salts. The purified GO were dispersed in de-ionized water to form a 0.2 mg.ml⁻¹ solution by sonication for 1 h. Then the GO dispersion was subjected to another centrifugation in order remove the un-exfoliated GO. The resulted GO dilute solution could remain in a very stable suspension without any precipitation for a few months.

The V₂O₅/Graphene nanocomposite was prepared simply by mixing the prepared GO suspension and the yellow solution of decavanadic acid (HVO₃) with the desired ratio. The obtained dark yellow solution was aged in a glass container for three weeks in order to obtain a completed cured homogeneous V₂O₅/GO hydrogels. Dried V₂O₅/GO xerogel was obtained by freeze-drying the V₂O₅/GO hydrogel under vacuum. The formed V₂O₅/GO xerogels were heated and annealed under N₂, at a rate of 5° C. min⁻¹ up to 400° C., and kept constant at 400° C. for two hours, during which, the graphene oxide was reduced to graphene.

The electrodes were prepared by spraying a slurry of 80% V₂O₅/Graphene nanocomposites, 10% polyvinylidence difluoride (PVDF) and 10% carbon black onto a 10 μm thick Al foil. For comparison, the pure V₂O₅·H₂) xerogel was synthesized in the same condition except the addition of the graphene oxide and the corresponding electrodes were prepared using the same procedure. The prepared electrodes were placed in a vacuum oven and allowed to dry at 90° C. for 24 h. The electrolyte consisted of a solution of 1.2 M LiPF₆ in a mixture of solvent from ethylene carbonate (EC) and ethyl methyl carbonate (EMC) (3:7, by weight).

The prepared V₂O₅/Graphene nanocomposites and pure V₂O₅ electrodes were assembled into R 2016 coin cells using Li metal anodes and dielectric separators for characterizing their electrochemical performance. These cells were tested with a battery cycler using different C-rates between 1.7 V and 3.6 V. AC impedance of these cells was measured in the frequency range of 0.01 Hz˜1 MHz with an amplitude of 5 mV.

High-resolution TEM characterization was performed at 200 kV. Cryogenic Temperature TEM analysis was carried out for the synthesized V₂O₅ hydrogel solutions with and without GO aged at different times to elucidate the formation mechanism. The 3.5 μL aliquot of the aged solution samples were placed on a copper grid (400 mesh) coated with a holey carbon film. The excess solution was blotted off with filter paper. The grid was then immediately plunged into liquid ethane cooled by liquid N₂. After that, the sample grid was loaded into the microscope with a side-entry cryogenic holder. Low-dose images were collected using a cryomicroscope with a filled emission gun operating at 200 or 300 kV, respectively. The thermo-gravimetric analysis was performed for both pure V₂O₅ and V₂O₅/Graphene nanocomposites using a thermoanalyzer.

Time-resolved high-energy XRD measurements were performed on the beam line 11-ID-C at the Advanced Photon Source, Argonne National Laboratory. A monochromator with a Si (113) single crystal was used to provide an x-ray beam with the energy of 115 keV. High-energy x-ray with a beam size of 0.2 mm×0.2 mm and wavelength of 0.108 Å was used to obtain two-dimensional (2D) diffraction patterns in the transmission geometry. X-rays were collected with a large-area detector placed at 1800 mm from the sample. The synthesized pure V₂O₅ and V₂O₅/Graphene nanocomposites were dried at 80° C. overnight and then pressed into pellets about 1 mm in thickness. The pellet then was placed between an alumina can and a platinum cover with hole (D=1 mm) on the centers of both can and cover. After that, the alumina can was then placed vertically in a programmable furnace with glass windows and Nitrogen was used as the protective gas. The sample was heated up to 600° C. with a heating rate of 2° C. per minute, simultaneously; the diffraction data of the sample was collected every 34 seconds. The obtained 2D diffraction patterns were calibrated using a standard CeO₂ sample and converted to 1D patterns using Fit₂D software.

The Li/V₂O₅ coin cells, with holes (D=2 mm) at the center, were assembled for XANES study. The holes were sealed to allow penetration of X-rays while preventing air entering the cell. XANES was performed at the K-edge of vanadium to monitor the change of the valence state of vanadium in the cathode material. The XANES measurements were carried out in transmission mode at beamline 20-BM of APS using a Si (111) monochromator. Energy calibration was performed by using the first derivative point of the XANES spectrum for V (K-edge=5465 eV). Meantime, the reference spectra were collected for each spectrum, where vanadium metal was used in the reference channel. The coin cells with the exact same electrodes were also used because the better signal/noise ratio. All cells were charged/discharged with a constant current about 0.1 C between 1.7 V and 3.6 V while the XANES spectra data was collected every 15 seconds.

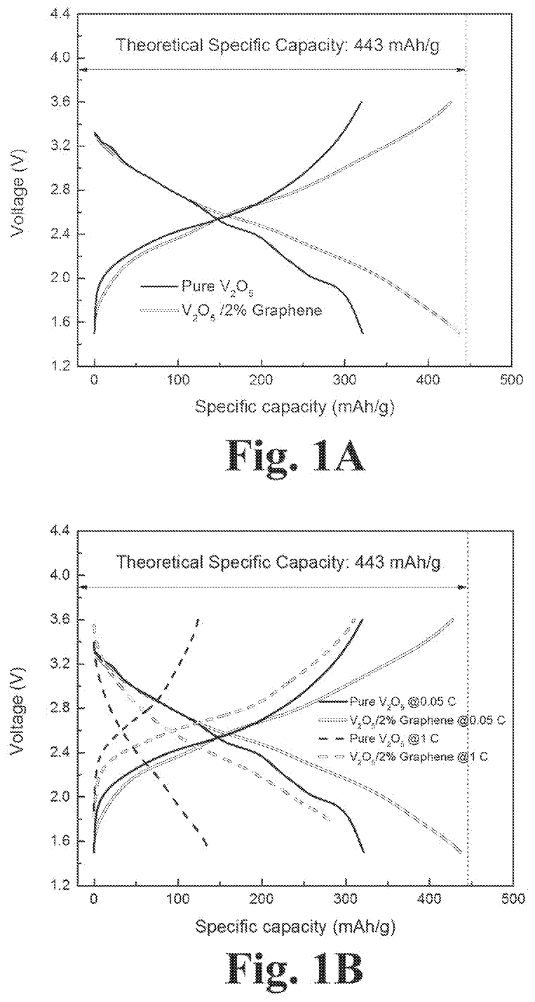

The introduction of the minute amount of graphene sheets (i.e. 2%) into the V₂O₅ gels has an extraordinary effect on their electrochemical performance. A specific capacity of 438 mAh/g (corresponding to 1034 Wh/kg and 3118 Wh/L) has been achieved at 0.05 C (FIG. 1a) for the V₂O₅/graphene nanocomposite with 2% graphene, which is almost the theoretical specific capacity, 98.87% of 443 mAh/g (theoretical value) while the pure V₂O₅ only delivered 324 mAh/g (corresponding to 777Wh/kg and 2344 Wh/L). Even at the higher rate, 1 C, such V₂O₅/graphene nanocomposite with 2% graphene still delivered 315 mAh/g (corresponding to 768 Wh/kg and 2311 Wh/L) (FIG. 1B), which is 2.23× of the pure V₂O₅, 137 mAh/g (corresponding to 299 Wh/kg and 901 Wh/L). The pure V₂O₅ discharge profile shows three distinct voltage stages: 3.3-2.5 V, 2.5-2.0V and 2.0-1.75V, corresponding to 1^{st}, 2^{nd} and 3^{rd} Li⁺ ion intercalation into V₂O₅ xerogel (FIG. 1B). However, no such stages were seen for the V₂O₅/graphene nanocomposite (2% graphene), which are typical for an amorphous material due to the absence of voltage plateaus associated with crystalline phase transitions¹⁵, suggesting that the V₂O₅/graphene nanocomposite (2% graphene) may have different structure from the pure V₂O₅. Although the second discharge capacity dropped to 419 mAh/g, such V₂O₅/graphene nanocomposite still can be used as high performance cathode materials for primary Li-V₂O₅ batteries.

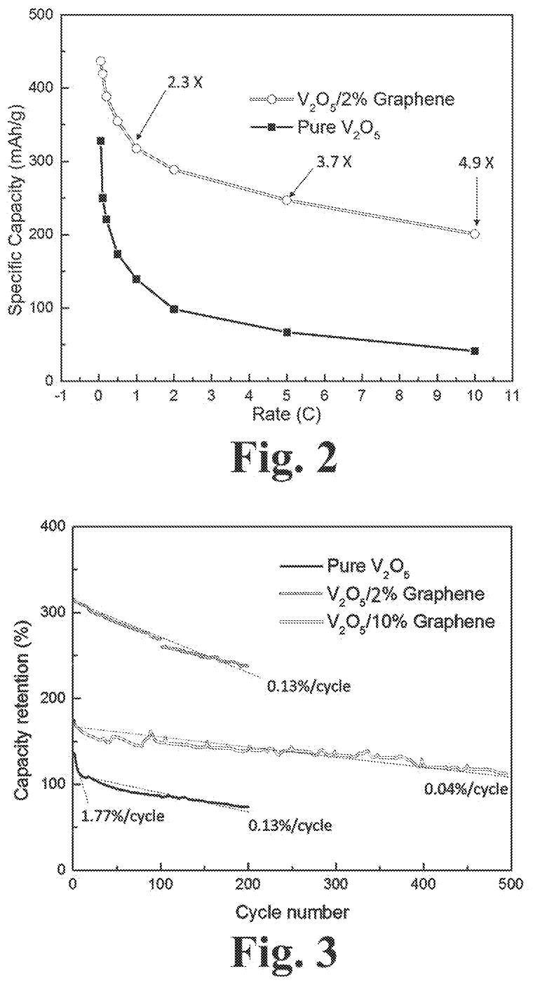

The introduction of graphene also shows significant effect on the rate performance which is the major issue for V₂O₅. At the fairly higher current densities, the V₂O₅/graphene nanocomposite still retains a high lithium ion storage capacity: 419 mAh/g at 0.1 C, 354 mAh/g at 0.5 C, 315 mAh/g at 1 C, 247 mAh/g at 5 C, and 201 mAh/g at 10 C compared with those of pure V₂O₅:250 mAh/g at 0.1 C, 173 mAh/g at 0.5 C, 137 mAh/g at 1 C, 67 mAh/g at 5 C, and 41 mAh/g at 10 C (FIG. 2). This corresponds to 67.6%, 104.6%, 130.0%, 268.7%, and 390.2% specific capacity increase at different rates respectively. Such huge improvement on the rate performance, in particular, at high rate (i.e. 10 C), suggests that the electric conduction of V₂O₅ xerogel has been tremendously increased, both interparticle and intra particle, just by introducing such tiny amount of graphene (2%). The increase on electric conductivity also indicated by our AC impedance study presented later.

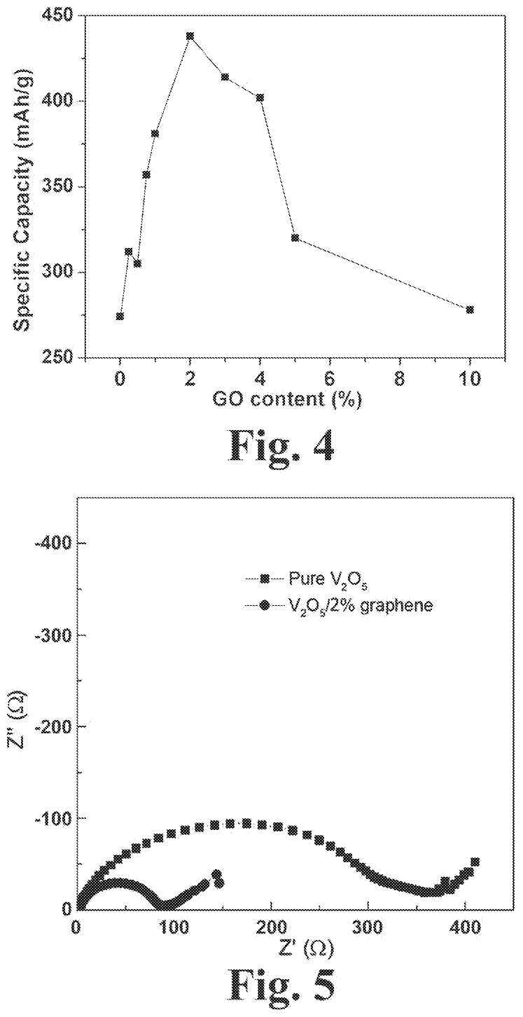

The synthesized V₂O₅/graphene nanocomposite also exhibits improved cycling stability. The V₂O₅/graphene nanocomposite (2% graphene) achieved 150 cycles with 80% initial capacity at 1 C rate while the pure V₂O₅ only achieved 11 cycles (FIG. 3) (The death criteria of a battery for EV and HEV is defined as 80% of its initial capacity, hence, we compare the cycle life at 80% initial capacity). The capacity decay rate is relatively stable for V₂O₅/graphene nanocomposite, 0.13%/cycle while the pure V₂O₅ shows two distinct different decay rates, initially sharply decays at 1.77%/cycle to 80% initial capacity after 11 cycles, after 12 cycles, decays at a much slow rate, 0.13%/cycle, indicating that the pure V₂O₅ might experience a structure change during the initial cycles, then the structure become stabilized.

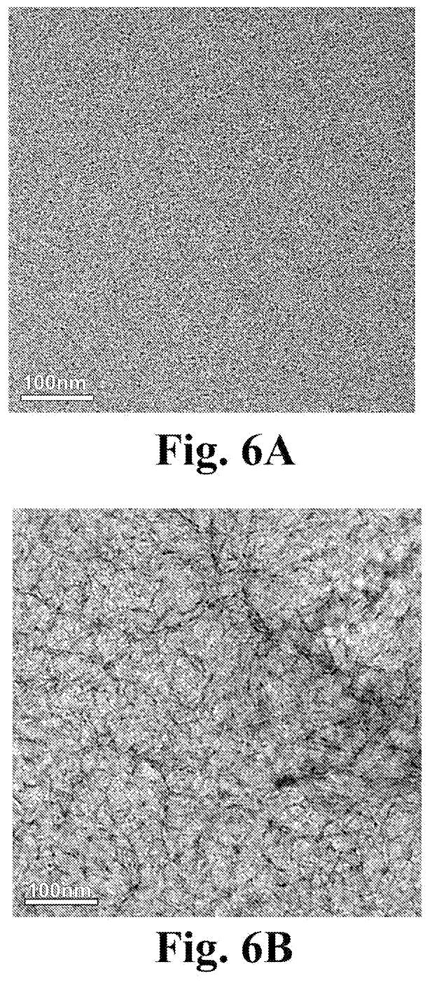

The content of graphene in the V₂O₅/graphene nanocomposite plays a critical role. It seems that 2% graphene results in the highest specific capacity, 438 mAh/g, (FIG. 4) while 10% graphene leads to a lower specific capacity, 278 mAh/g, but a much improved cycle stability, 497 cycles. It is speculated that the less graphene content may result in a better dispersion of graphene sheets in the hydrogel of V₂O₅ (remaining as a single sheet) which helps to insert single or double sheets of graphene into the V₂O₅ nanoribbons while higher graphene content may lead to restacking of the graphene sheets as we observed in our previous work, but the thick stack of graphene (i.e. 3-5 graphene sheets per stack) may hold the V₂O₅ nanoribbons tighter to maintain the structure integrity, consequently, a much better cycle life. Another possibility is that higher graphene conent may lead to a more complete coverage over V₂O₅ nanoribbons which help to hold the ribbons together from collapsing.

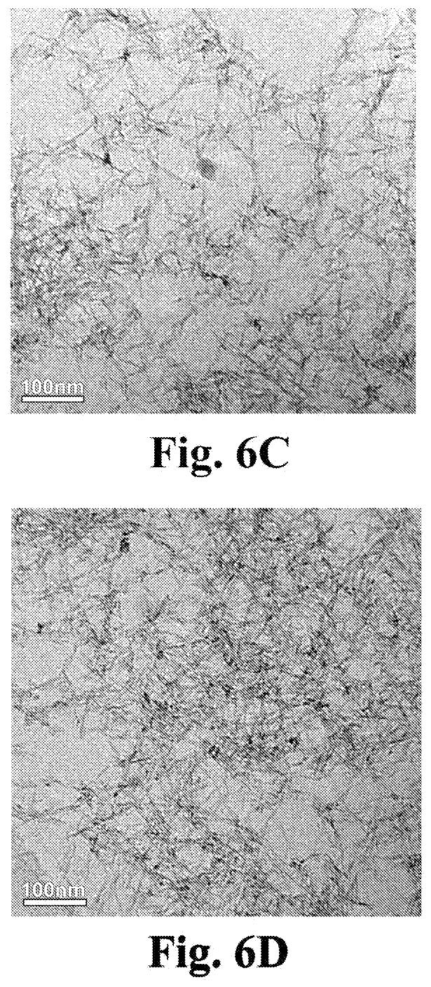

AC impedance spectra of both pure V₂O₅ and V₂O₅ /graphene nanocomposite were measured. The results (FIG. 5) were fitted using the model shown in the FIG. 5, where R₀, is the contact resistance, Rₑ and Cₑ refer to the resistance and capacitance of the V₂O₅ electrode, R_{ct} and C_{dl} stand for the charge-transfer resistance of redox reaction of vanadium in V₂O₅ and double-layer capacitance in the electrode, respectively, and the W_{d} refers to the Warburg diffusion impedance, which could reflect the diffusion of Li ions in the V₂O₅. The fitting results are listed in table 1. Clearly, the tiny amount of graphene sheets in V₂O₅ cause the huge change of the electric conduction, Rₑ, from 309.48Ω of pure V₂O₅ to 86.55Ω of V₂O₅/graphene nanocomposite, an order of magnitude change (both the pure V₂O₅ and the V₂O₅/graphene nanocomposite electrodes had the exact the same composition and were made in the same procedure under the same condition, the change of Rₑ must be due to the conductivity of V₂O₅ gels). The redox of vanadium in the V₂O₅ gels also has been significantly increased, R_{ct} changed from 46.88Ω of pure V₂O₅ to 10.94Ω of V₂O₅/graphene nanocomposite, a 4.28× changes, which also explains the increased rate performance. Finally, the Lⁱ⁺ ion diffusion within the _{V2O5} gels has been improved, the W_{d} changed from 0.451 to 0.396, corresponding to the Lⁱ⁺ diffusion coefficient in V₂O₅ gels from 1.21 E-12 to 1.57 E-12 cm²/s, 12% increase. Thus, the AC impedance results show that our approach indeed works as we designed.

TABLE 1
Summary of AC impedance spectra fitting results

| Cell | Rs | Ce | Re | Cdl | Rct | W |
|---|---|---|---|---|---|---|
| Pure V₂O₅ | 2.008 | 2.73E−6 | 309.48 | 1.33E−6 | 46.88 | 0.451 |
| | | | 3.231 × 10−3S | | | |
| V₂O₅/2% | 1.927 | 2.96E−6 | 86.55 | 1.72E−6 | 10.94 | 0.396 |
| Graphene | | | 1.16 × 10−3S | | | |

It is clear that the introduction of such tiny amount (i.e. 2%) graphene has the profound effect on the electrochemical performance of V₂O₅ and such V₂O₅/graphene nanocomposite shows the best electrochemical performance of V₂O₅ xerogels in the coin cell configuration as compared with others' work summarized in table 2. However, all performance changes are rooted in the materials structure. Hence, to understand the structure and the formation mechanism of V₂O₅/graphene nanocomposite, the XANES and HES XRD were carried out as well as the cryo-TEM and the results are presented below.

TABLE 2
Comparison of the best electrochemical performance of V₂
O₅ composite and other's work in the coin cell configuration

| | First initial capacity | | | | Cycle performance | | |
|---|---|---|---|---|---|---|---|
| | | C-rate or | | Voltage | | C-rate or | |
| Sample | mAhg⁻¹ | Current density | | range, (V) | Cycle number | Current density | |
| Eu_{0.11}V₂O₅, | 269 | 15 | μAg⁻¹ | 1.5-4.0 | 10 | 15 | μAg⁻¹ |
| xerogels¹ | | | | | (2%)capacity | | |
| | | | | | fade per cycle | | |
| PPy/V₂O₅² | 160 | C/40 | | 2.0-4.0 | 30 | C/40 | |
| hybrid | | | | | (0.4%)capacity | | |
| | | | | | fade per cycle | | |
| Graphene/V₂O₅³, | 299 | 30 | mAg⁻¹ | 1.5-4.0 | 30 | 30 | mAg⁻¹ |
| xerogels | | | | | (0.7%)capacity | | |
| | | | | | fade per cycle | | |
| V₂O5⁴ | 223 | C/20 | | 1.5-4.0 | 10 | C/20 | |
| xerogel | | | | | (2%)capacity | | |
| | | | | | fade per cycle | | |
| Cu_{0.1}V₂O₅⁵, | 136 | 0.15 | mA/cm² | 1.5-4.0 | 450 | 0.15 | mA/cm² |
| xerogel | | | | | No capacity loss | | |
| Ag_{0.1}V₂O₅⁶, | 340 | C/20 | | 1.5-4.0 | 24 | C/20(discharge) | |
| xerogel | | | | | (0.4%)capacity | C/40 (charge) | |
| | | | | | fade per cycle | | |
| Carbon-coated | 297 | 1.0Ag⁻¹ | | 2.0-4.0 | 50 | 1.0Ag⁻¹ | |
| V₂O₅⁷ | | | | | No capacity loss | | |
| nanocrystal | | | | | | | |
| V₂O₅ | 275 | 0.125 | C | 2.05-4.0 | 20 | 0.2 | C |
| microspheres⁸ | | | | | (0.38%)capacity | | |
| | | | | | fade per cycle | | |
| V₂O₅ | 275 | 0.2 | C | 2.0-4.0 | 50 | 0.2 | C |
| nanoflower⁹ | | | | | (0.26%)capacity | | |
| | | | | | fade per cycle | | |
| V₂O₅ | 275 | 30 | mAg⁻¹ | 2.0-4.0 | 50 | 30 | mAg⁻¹ |
| nanowire¹⁰ | | | | | (0.50%)capacity | | |
| | | | | | fade per cycle | | |
| V₂O₅/graphene | 438 | 0.05 | C | 1.5-4.0 | 137 (to 80% | 1 | C |
| nanocomposite | | | | | initial capacity) | | |
| | | | | | (0.13%)capacity | | |
| | | | | | fade per cycle | | |

The synthesis process of V₂O₅/graphene nanocomposite was studied using cryo-TEM. As described above, NaVO₃ becomes yellow colored HVO₃ after passing through a ion exchange column, then this dilute HVO₃ starts to slowly form V₂O₅ hydrogel via protonation of HVO₃ (usually within a several minutes) and the solution gradually change color from yellow to dark brown and eventually (usually after 1-2 weeks), dark red, which indicated the completion of the formation of a 3-D network of V₂O₅ hydrogel. The 3.5 μL aliquot of HVO₃ solution was taken at 0, 30, 45, 60, 90, 120, 360 min, 1, 2 and 3 weeks to monitor the process of initializing, nucleating, ribbon growing for V₂O₅ gels (the time at 0 min refers to the time when about 5 mL HVO₃ solution came out from the ion exchange column). The advantage of the cryo-TEM is that it can directly observe the micorgeometry and the morphology of particles within a liquid without disturbance by fast freezing the liquid sample using liquid nitrogen, which preserves the morphology and microgeometry of the particles in the original liquid as we have successfully used the cryo-TEM in our previous work.

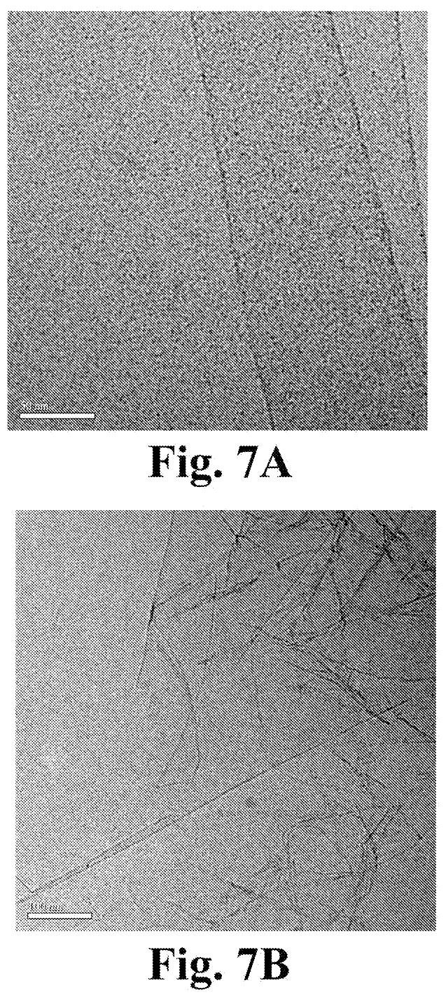

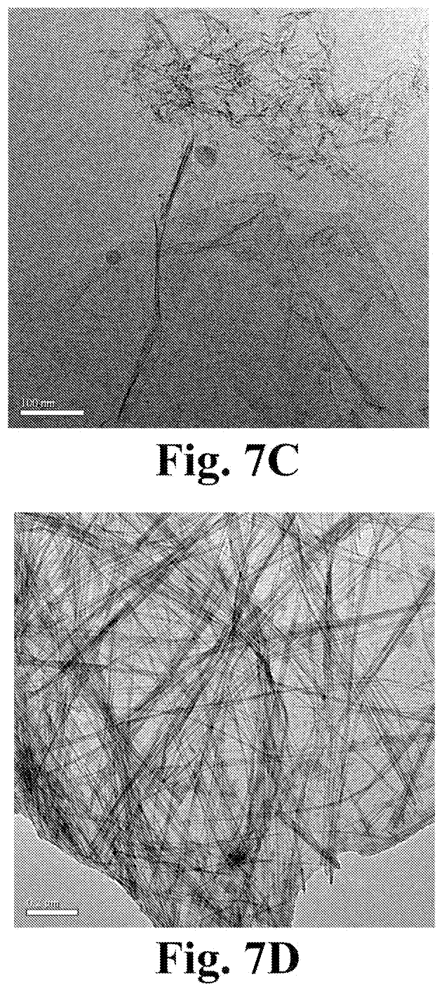

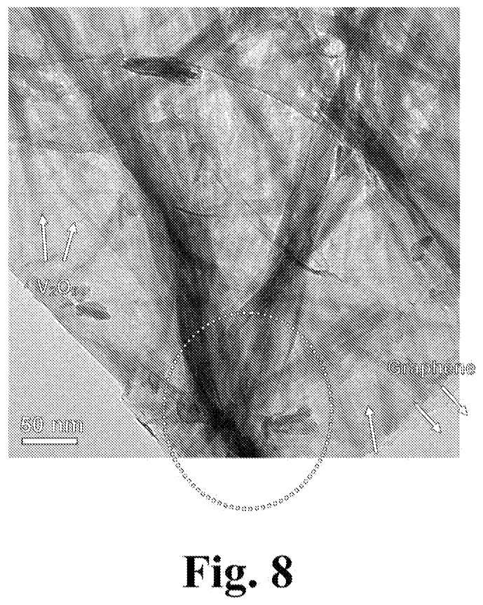

It can be seen (FIG. 6A) that nucleation immediately occurred (0 min) once the decavanadic acid (HVO₃) solution is formed (right after NaVO₃ passing through the ion exchange column), then small V₂O₅ ribbon started to grow into 100 nm long ribbon with diameter in a few nm shown in 60 min image (FIG. 6B) and the V₂O₅ ribbons continuously grow along width direction more than length direction and the length seems not grow too much in 90 min image (FIG. 6C) and finally, after 2 weeks, the V₂O₅ hydrogel network was formed with similar the length but much large with of the V₂O₅ ribbons. When the graphene oxide was added into the decavanadic acid (HVO₃) solution, the V₂O₅ hydrogel formation took place on the surface of the graphene oxide sheets, nucleating, ribbons forming, ribbons growing and V₂O₅ hydrogel network forming. Upon adding GO solution into the decavanadic acid solution, the nuclei formed in the beginning will tend to adsorb on the GO sheets due to the Columbic interaction and van der Waals between the nuclei and GO. In contrast to the pure V₂O₅, the nucleation of V₂O₅ hydrogel in the presence of graphene oxide sheets took much longer time, after 30 min, the nucleation starts (FIG. 7a), which probably is due to the repulsive effect from the some regions of the GO surface having negative charges of the different functional groups (i.e. phenol, carbonyl, ketone, etc). After 120 min, very few piece of V₂O₅ ribbons can be barely seen (FIG. 7b). Even after 4 h, the V₂O₅ ribbons continuously grew but in much less density than pure V₂O₅ (FIG. 7c). Finally, it took 3 weeks to form the fully grew V₂O₅ hydrogel network (FIG. 7d). However, the V₂O₅ ribbons in the fully grew V₂O₅ hydrogel on the graphene oxide surface look more uniform with much smaller range of width and much less dense arranged than the pure V₂O₅ hydrogel (comparing FIGS. 6d and 7d). This may be attributed to the existence of graphene oxide sheets which provide the substrate for V₂O₅ hydrogel formation but in a much slower rate, facilitating the crystal growth rather nucleation due to the negative charge repulsion. Thus, the formed V₂O₅ ribbons with smaller width and much less dense arranged over the GO surface. This does lead to the smaller grain size of V₂O₅ ribbons which results in the improved Li⁺ diffusion as indicated by AC impedance results. The less dense arranged V₂O₅ ribbons over the GO surface also result in the more gaps between V₂O₅ ribbons, providing more surface area for Li⁺ diffusion into ribbons. Likely, the graphene sheets serving as substrate for V₂O₅ ribbons lead to the tremendous increase on the electric conductivity. On the other hand, the V₂O₅ formation over GO surface requires that the V₂O₅ anchoring on GO first, which makes the overall V₂O₅ ribbon formation take much longer than in liquid. Since the GO is single-layer, the GO sheets will act as spacers to create gaps between the formed V₂O₅ nanoribbons once the water is removed from the V₂O₅ hydrogel by heating. In the other words, the V₂O₅ nanoribbons would be sandwiched between layers of graphene after the annealing. Such V₂O₅ nanoribbons sandwiched between grahene sheets can be clearly seen in FIG. 8, in which the V₂O₅ nanoribbons, with 5-10 nm diameter, lay on the plane of graphene sheets (as pointed out by the arrows) (comparing pure V₂O₅ nanoribbons, 5-20nm) . Also, some V₂O₅ nanoribbons were anchored on or sandwiched between the graphene sheets (as pointed out in the yellow dash circle region). The structure of V2O5 and V2O5 graphene, schematic of graphene satwiched between V2O5 layer.

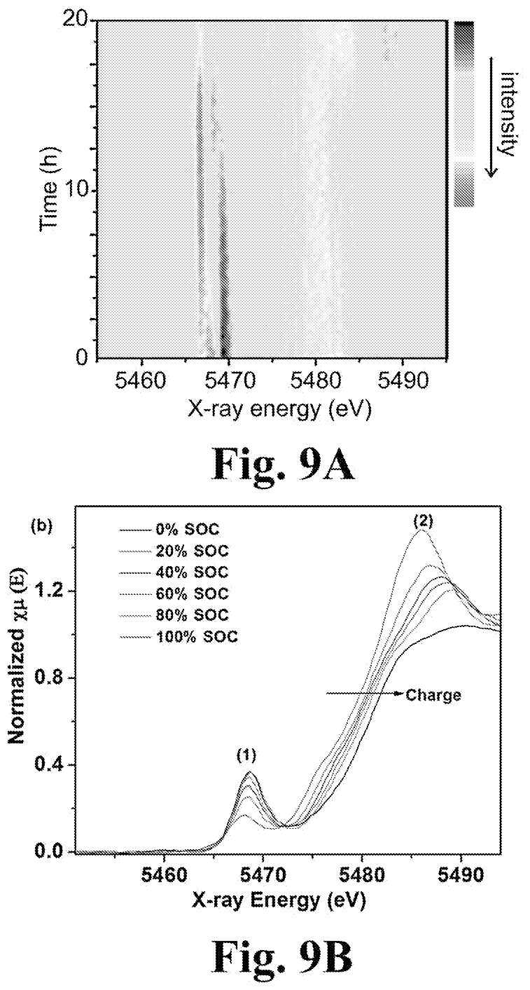

A coin cell containing this nanocomposite electrode was cycled during an XANES experiment. The obtained XANES results are shown in FIG. 9. The contour plot of 2D vanadium K-edge XANES data during the initial discharge cycles is shown in the FIG. 9a. Clearly, the X-ray edge energy continuously shifts to a lower energy with the incremental increase of the lithium content in V₂O₅ cathode from 0 to 20 h. The negative energy shift of V₂O₅ is obviously consistent with the reduction of vanadium to lower oxidation state. FIG. 9b shows the several vanadium K-edge XANES spectra, illustrating the insertion of Li⁺ into V₂O₅ during the first discharge.

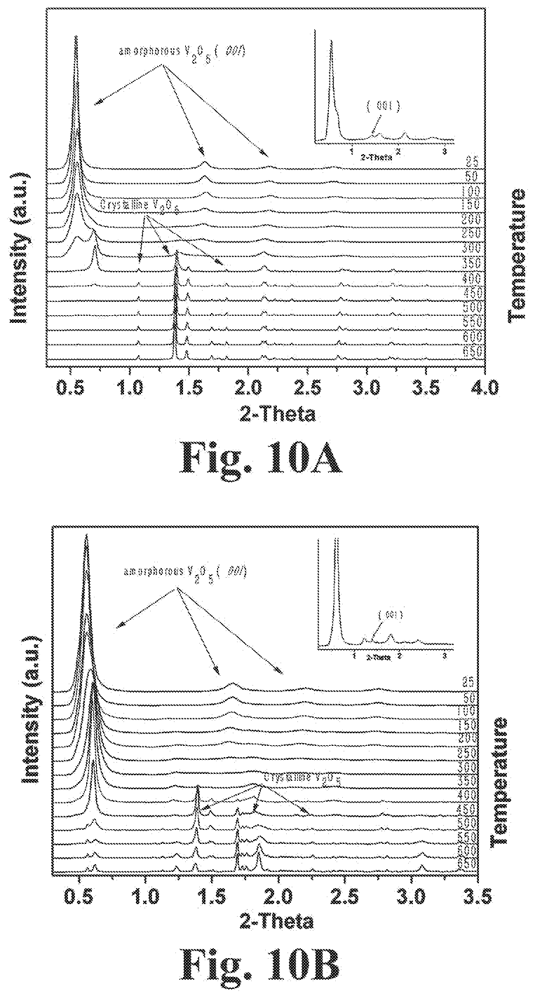

The synchrotron high energy XRD was measured for both V₂O₅/graphene nanocomposite and pure V₂O₅ (as reference) during heating process (from room temperature to 600° C. at rate of 10° C. per minute). The results for pure V₂O₅ are shown in FIG. 10a. Initially, the sample showed the layered hydrated V₂O₅ (00l) reflections, typical amorphous structure, and the layer structure was maintained until about 200° C., then, the (00l) reflection shifted slowly to the higher 2-theta angle, and the shift is primarily caused by the loss of water between V₂O₅ layers, resulting in the shortening of the interlayer spacing (d spacing) between V₂O₅ layers. The phase transition from amorphous to crystalline phase started around 200° C., as it could be seen in the FIG. 10a (inset): the new emerged peak around 1.42° is attributed to the orthorhombic crystalline V₂O₅ (JCPDS No. 41-1426). Obviously, the loss of water from V₂O₅ layers will result in such phase transformation. As the temperature continues to increase, the peak intensity of the orthorhombic crystalline V₂O₅ rapidly increased at the expense of the relative peak intensity of layer hydrated structure (amorphous). Finally, around 400° C., the amorphous phase almost completely diminished and the phase transformation completed. The V₂O₅ gel structure collapsed, likely due to the complete removal of water from the V₂O₅ upon heating to 400° C., then, the V₂O₅ gel completely transformed into V₂O₅ nanocrystal which shows three distinct discharge stages in FIG. 1.

It is interesting to note that the graphene has a significant impact on the structure of the V₂O₅ gel. Initially, the V₂O₅/graphene nanocomposite showed the layer hydrated structure similar to that of the pure V₂O₅ gel but with the smaller interlayer spacing (d-spacing). As the temperature increased, the (00l) reflection shifted to the higher 2-theta angle as that of pure V₂O₅ sample, but in a much slower rate. Unlike the pure V₂O₅,which phase transition from amorphous to crystal phase started around 200° C., the phase transition for V₂O₅/graphene nanocomposite started around 400° C. as indicated by the emerged peak at 1.42° (FIG. 10b). With the presence of graphene, the amorphous-to-crystalline phase transition was delayed. In analogy to the pure V₂O₅ xerogel sample, for the composite sample the thermal stability has been greatly enhanced when the V₂O₅ layer is affixed to the graphene sheets.

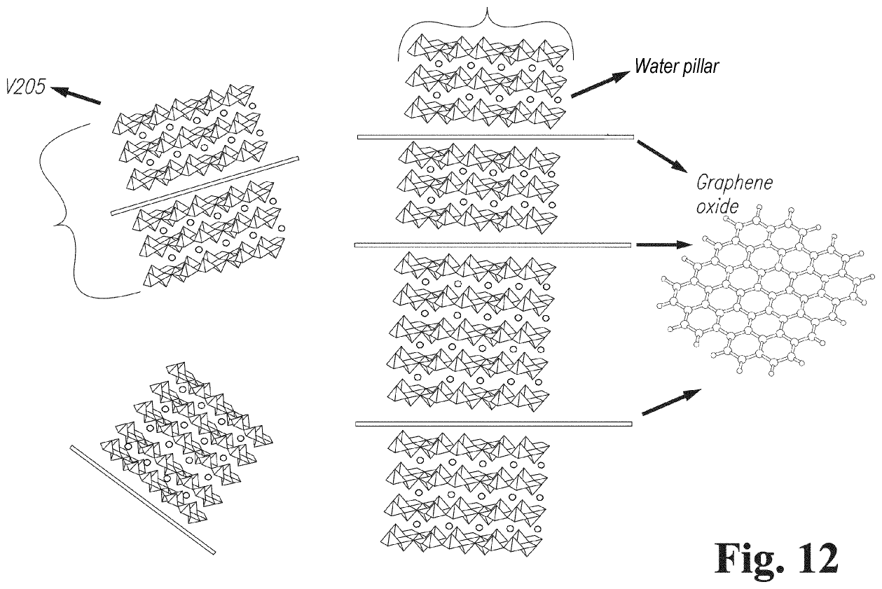

For the electrochemical performance testing, the obtained V₂O₅/graphene nanocomposite was annealed at 400° C. under N₂ atmosphere before used as the cathode. Based on the synchrotron HEXRD data in FIG. 10b, the calculated V₂O₅ interlayer spacing, d-spacing, is 10.2Å, corresponding to 0.3 water per V₂O₅, V₂O₅·0.3H₂O. However, for the pure V₂O₅, there is almost no water left even after 300 ° C. and the structure is completely changed to nanocrystal instead of amorphous V₂O₅ gel. Water inside V₂O₅ gels functions as the pillars to keep the interlayer space between two V₂O₅ sheets as shown in FIG. 12. Without water as pillars, the V₂O₅ network in the amorphous V₂O₅ gels will likely collapse and become crystal V₂O₅ during annealing, which has much less electrochemical performance. Hence, a minimum water is needed to keep the amorphous phase. Thus, the graphene sheets inside the V₂O₅ layers does increased its thermal stability, preserve the amorphous phase even at 400° C., with 0.3 water per V₂O₅. The V₂O₅/graphene nanocomposite may include a substantially equal number V₂O₅ and graphene sheets or, as shown in FIG. 12, a greater number of V₂O₅ sheets than graphene sheets.

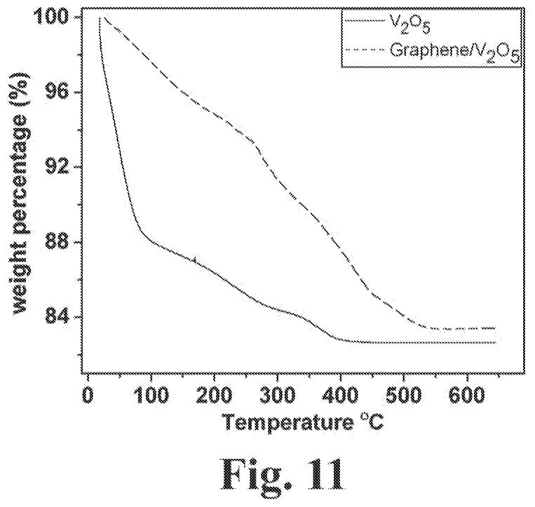

Thermogravimetric analysis (TGA) was also carried out for both pure V₂O₅ xerogel and V₂O₅/graphene nanocomposite for studying their structure change during annealing and the results are shown in FIG. 11. The pure V₂O₅ xerogel had a rapid weight loss (0.15%/° C.) until 80° C., followed by a gradual weight loss in a much slow rate (0.018%/° C.) up to 300° C., which is corresponding to the loss of weakly bonded water molecules in V₂O₅ xerogel. As temperature went to beyond 300° C., the tightly bonded water molecules were removed and the phase conversion from amorphous phase to orthorhombic phase started, which is consistent with the HEXRD results. Compared to the pure V₂O₅ xerogel, the V₂O₅/graphene nanocomposite showed a complete different profile; it had a gradual weight loss at the rate of 0.024%/° C. until 250° C., which is characteristic of the loss of weakly bonded water from the V₂O₅/graphene gel. Then it followed by another gradual weight loss with a slightly fast slope (0.05%/° C.) until 450° C., before which the bipyramid structure still persist, through orthorhombic vanandium pentoxide start to emerge around 400° C. The TGA results further verified that the thermal stability of the V₂O₅ has been greatly enhanced with the presence of graphene.

Historically, graphene has been considered as ideal conducting materials to improve the electric conduction and enhance the structure of V₂O₅. However, the graphene was simply added into V₂O₅ by simply mixing graphene with V₂O₅. Such simple physical mixing usually requires a high graphene loadings (e.g. 30% graphene), which led to a significant improvement on the cycle life and rate performance, but with the heavy penalty on the specific capacity. In this work, a method of creating V₂O₅/graphene nanocomposite via sol-gel process has been developed and the tiny amount of graphene sheets (e.g. 2%) has a profound effect on the structure, consequently resulting in an extraordinary electrochemical performance without the heavy penalty on specific capacity, rather achieving almost the theoretical specific capacity. The performance of electrode materials is always rooted in the materials structure. We clearly demonstrated through our HEXRD, that the graphene sheets help to preserve the V₂O₅ xerogel structure and keep the xerogel from collapsing by maintain 0.3 water molecules per V₂O₅ during annealing process. In addition, the AC impedance proved that the electric conduction, the vanadium redox reaction and Li⁺ diffusion have been improved due to such tiny amount of graphene.

Thus, a novel and simple method has been developed to incorporate the graphene sheets into the nanostructure of V₂O₅ gels via a sol-gel process to form a V₂O₅/graphene nanocomposite. The introduction of such tiny amount of graphene into V₂O₅ gels can effectively alter the structure of the nanocomposite, resulting in the significant improvement on electric conduction, structure stability and ion diffusion, which in turn results in an extraordinary electrochemical performance of V₂O₅/graphene nanocomposite: reaching almost the theoretical specific capacity, excellence rate performance and greatly enhanced cycle life. This method provides a new avenue to create nanostructured materials with improved properties for metal oxides as long as they can be synthesized via sol-gel process or reaction in solutions. The sol-gel process along with the solution method makes such method easy for scale-up, which make the wide-spread industrial application of these new materials feasible.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1-9. (canceled)

10. A method for preparing a vanadium oxide cathode material:
a) preparing a graphene oxide (GO) suspension;
b) mixing the graphene oxide suspension with decavanadic acid (HVO₃) in a predetermined ratio to yield an admixture;
c) curing the admixture to yield a homogeneous V₂O₅/GO hydrogel;
d) annealing the V₂O₅/GO hydrogel to yield an annealed material; and
e) freeze drying the annealed material to yield a xerogel;
wherein the xerogel is about 98 percent V₂O₅ by weight.

11. The method of claim 10 and further comprising:
f) preparing a slurry of 80 weight percent xerogel, 10 weight percent polyvinylidence difluoride (PVDF) and 10 weight percent carbon black;
g) spraying the slurry onto a metal foil to yield a green electrode; and
h) drying the green electrode to yield a composite electrode;
wherein the composite electrode retains a water content of about 0.3 moles water for every mole of V₂O₅.

12. The method of claim 11 and further comprising:
i) operationally connecting the composite electrode to a lithium anode via an intervening lithium electrolyte medium to define an electrochemical cell.

13. The method of claim 11 wherein the composite electrode defines a plurality of adjacent layers of vanadium pentoxide; wherein respective graphene oxide sheets are positioned between adjacent layers of vanadium pentoxide; wherein water molecules are positioned between adjacent layers of vanadium pentoxide; and wherein the molar ratio of water to vanadium pentoxide is about 0.3 to 1.

14. The method of claim 10 wherein the GO is reduced to graphene during step d).

15. An electrode material for an electrochemical cell, comprising:
a plurality of vanadium pentoxide ribbons defining a substrate;
a plurality of graphene oxide sheets infiltrating the substrate, wherein:
each graphene oxide sheet is located between two adjacent vanadium pentoxide ribbons;
the graphene oxide sheets are present in an amount of about 2 weight percent of the electrode material; and
interlayer spacing between two adjacent vanadium pentoxide ribbons is equal to or between about 10.2 angstrom and 11.5 angstrom; and
crystalline water in an amount sufficient to maintain the interlayer spacing between the vanadium pentoxide ribbons.

16. The electrode material of claim 15 wherein water of the crystalline water is present in an amount of about 0.3 molecules per vanadium oxide.

17. The electrode material of claim 16 wherein the plurality of graphene oxide sheets infiltrate the substrate such that a single graphene sheet is located between two adjacent vanadium pentoxide ribbons.

18. The electrode material of claim 17 wherein the electrode material is annealed.

19. The electrode material of claim 18 wherein the interlayer spacing is about 10.2 angstrom.

20. The electrode material of claim 15 wherein the plurality of graphene oxide sheets infiltrate the substrate such that a single graphene sheet is located between two adjacent vanadium pentoxide ribbons.

21. The electrode material of claim 20 wherein the interlayer spacing is about 10.2 angstrom.

22. The electrode material of claim 21 wherein the electrode material is annealed.

23. The electrode material of claim 15 wherein the electrode material is annealed.

24. The electrode material of claim 23 wherein the interlayer spacing is about 10.2 angstrom.

25. The electrode material of claim 15 wherein the interlayer spacing is about 10.2 angstrom.

26. The electrode material of claim 15 wherein the plurality of vanadium oxide ribbons define an amorphous substrate.

27. The electrode material of claim 26 wherein the electrode material is a gel.

28. The electrode material of claim 15 wherein the electrode material is a gel.

29. A cathode formed from the electrode material of claim 15.

30. A lithium ion battery including the cathode of claim 29.
